(19) United States
(12) Patent Application Publication
(10) Pub. No.: US 2002/0165582 A1
(43) Pub. Date: Nov. 7, 2002

(54) Method and apparatus for delivering materials to the body

(76) Inventor: Christopher H. Porter, Woodinville, WA (US)

Correspondence Address: Finnegan, Henderson, Farabow,, Garrett & Dunner, L.L.P., 1300 I Street, N.W., Washington, DC, 20005-3315, US

(21) Appl. No.: 10/133,759

(22) Filed: Apr. 25, 2002

Related U.S. Application Data
(60) Provisional application No. 60/287,029, filed on Apr. 26, 2001.

(51) Int. Cl. A61D 1/00

(52) U.S. Cl. 606/213

(57) ABSTRACT

An apparatus, method and composition for embolization of a vascular site in a blood vessel. The composition is introduced via catheter to the vascular site and activated by an activator introduced by the catheter or external means. The composition polymerizes or precipitates in situ via the activation provided by the catheter or external means.

Applicant claims the right to priority under 35 U.S.C. §119(e) based on Provisional Patent Application No. 60/287,029 entitled “NOVEL METHOD AND APPARATUS FOR DELIVERING MATERIALS TO THE BODY,” filed Apr. 26, 2001, and which is expressly incorporated herein by reference in its entirety.

### DESCRIPTION OF THE INVENTION

### Field of the Invention

The present invention relates to methods of delivering materials to the body to bulk tissue or fill voids. More specifically, the present invention relates to embolizing blood vessels for treating vascular lesions such as aneurysms.

### Background of the Invention

Embolization of blood vessels can be conducted for a variety of purposes including the treatment of tumors, the treatment of lesions such as aneurysms, arteriovenous malformations (AVM), arteriovenous fistula (AVF), uncontrolled bleeding and the like.

Embolization of blood vessels can be accomplished via catheter techniques which permit the selective placement of the catheter at the vascular site to be embolized. In this regard, recent advancements in catheter technology as well as in angiography now permit neuro endovascular intervention including the treatment of otherwise inoperable lesions. Specifically, development of microcatheters and guide wires capable of providing access to vessels as small as 1 mm in diameter allows for the endovascular treatment of many lesions.

Surgical intervention can be undertaken to correct AVMs. Interventional radiologic approaches also are used to obliterate AVMs by embolization, in which the goal of embolization is to selectively obliterate an abnormal vascular structure, while preserving blood supply to surrounding normal tissue. Embolization can be accomplished using low-profile soft microcatheters that allow superselective catheterization into the brain to deliver an embolic material under fluoroscopic guidance. Various embolic materials have been used in endovascular treatment in the central nervous system, such as cyanoacrylates, ethylene-vinyl alcohol copolymer mixtures, ethanol, estrogen, poly(vinyl acetate), cellulose acetate polymer, poly (vinyl alcohol), gelatin sponges, microfibrillar collagen, surgical silk sutures, detachable balloons, and coils. Delivery of these embolic materials often requires the use of elaborate delivery systems.

The use of polymer compositions to embolize blood vessels has been disclosed including compositions wherein a preformed polymer precipitates in situ from a carrier solution at the vascular site to be embolized. For effective treatment, such polymer compositions must form a precipitate in the blood vessel having sufficient structural integrity to inhibit fragmentation of the precipitate and the precipitate must be anchored at the site of placement. While certain polymer compositions form precipitates having the requisite structural integrity, other polymer compositions do not. In either case, anchoring of these precipitates to the vascular site remains a serious problem particularly in lesions having high blood flow and/or diffuse necks. In such cases, precipitate anchoring to the vascular site is not an intrinsic function of the shape of the lesion to be treated and migration of the precipitate away from the intended vascular site can occur.

The drawbacks of using a polymer dissolved in a solvent that is precipitate when injected into the treatment area, include (1) the viscosity and set-up characteristic depend on the solvent, (2) the set-up period is determined by the diffusion characteristics and the geometry of the treatment area, (3) the delivery of solvent into the patient, (4) the limitations on materials which can be used, (5) the potential for water entering the catheter and blocking the tip, or causing non-adhesion to the tissue or non-adhesion to itself, (6) a cumbersome delivery system designed to exclude water from the delivery catheter before and during injection, to keep the catheter stable during injection, and to keep the polymer in place until it sets up. Typical delivery time can be three hours.

Hydrophilic catheter coatings have been developed in the hope of reducing the risk of inadvertent endovascular catheter fixation during embolization due to reduced bond strength between the hydrophillically coated catheter and the polymer. However, micro catheter adhesion remains a problem during intravascular embolization. Inadvertent gluing of the catheter tip onto the artery is a well recognized and distressing complication. Vessel rupture or occlusive embolization of a detached catheter tip can occur if excessive force is used to attempt to retrieve the catheter. Although hydrophilically coated catheters have the potential of decreasing the occurrence of inadvertent endovascular catheter fixation, the level of operator proficiency and experience, and perhaps most importantly, the actual adhesive composition that is used stills play a major role in these events.

It is accordingly desirable to provide a low viscosity prepolymer system to be delivered through small catheters or needles into the area that needs to be treated. It is also desirable that these prepolymers set-up or at least partially polymerize rapidly so that they stay in place. It is also desirable to avoid catheter movement during injection of the prepolymer.

This is achieved by a method and apparatus, which comprises a material that during delivery exists in a first state that makes it easy to deploy. Once deployed, or during the deployment process, the substance is converted to a second state by the operator activation a process which causes the material to change its properties and become a stable mass.

The present invention can be applied to any site in the human body that needs to be filled. The embodiments discussed in the detailed description include those that apply to embolization of vascular sites. The apparatus, methods, and compositions described apply to any site in the human body that needs to be filled or bulked.

The present invention can use any changed of state to in delivering the composition through a catheter and at least partially solidifying the composition in the site. This can include polymerization, precipitation, crystallization, phase transition, and any other solidification process known in the art. The embodiments discussed in the detailed description include those that apply to polymerization and precipitation. The apparatus and methods described can use any change of state.

It is noted that, as used in this specification and the appended claims, the singular forms “a,” “an,” and “the” include plural referents unless expressly and unequivocally limited to one referent. Thus for example, reference to “a prepolymer” includes two or more prepolymers. Also noted that as used herein, the term “polymer” is meant to refer to polymers, oligomers, homopolymers, and copolymers.

For the purposes of this specification and appended claims, unless otherwise indicated, all numbers expressing quantities of ingredients or percentages or proportions of other materials, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “1 to 10” includes any and all subranges between (and including) the minimum value of 1 and the maximum value of 10, that is, any and all subranges having a minimum value of equal to or greater than 1 and a maximum value of equal to or less than 10, e.g., 5.5 to 10.

### SUMMARY OF THE INVENTION

In accordance with the invention, a method for embolization of a vascular site in a blood vessel comprises delivering a prepolymer composition to a vascular site, introducing an activator to the vascular site to at least partially polymerize the prepolymer composition in situ. The activator can comprise at least one type of electromagnetic radiation chosen from gamma rays, X-rays, ultraviolet waves, light waves, infrared waves, and radio waves. The activator can comprise a magnetic field, a composition, or ultrasound energy.

In accordance with the invention, an apparatus for embolization of a vascular site in a blood vessel comprises a catheter to deliver a prepolymer to the vascular site where the prepolymer is adapted to at least partially polymerize in situ by introducing an activator, and the catheter is adapted to at least partially adhere to the polymerized prepolymer. In certain embodiments, the catheter is adapted to introduce the activator. In those embodiments, the catheter can also comprise a fiber optic to introduce light waves to the vascular site, a heating element to introduce infrared waves to the vascular site, a heating fluid to introduce a temperature change to the vascular site. In certain embodiments, the activator can also be introduces by means other than the catheter (i.e. not introduced by the same catheter), or external means such as an instrument to deliver focused ultrasound to the vascular site, or an instrument to deliver eddy currents to the vascular site, or an instrument to deliver a magnetic field to the vascular site, or an instrument to deliver electromagnetic radiation to the vascular site.

In accordance with the present invention, a composition to embolize a vascular site in a blood vessel comprises a prepolymer, wherein the prepolymer is adapted to at least partially polymerize in situ by introducing an activator thereby embolizing a vascular site in a blood vessel. In certain embodiments, the prepolymer can comprise a light-activated cross-linking material and/or a heat-activated cross-linking material. In certain embodiments, the prepolymer can be contained within microbeads. These microbeads can comprise magnetic particles adapted to heating by at least one external field chosen from a electromagnetic field, radio waves, and an microwaves. In other embodiments, the microbeads can comprise a catalyst to polymerize the prepolymer.

In accordance with the present invention, a composition for the embolization of a vascular site in a blood vessel comprises a first material adapted to at least partially polymerize and a second material adapted to initiate the polymerization, wherein the first material is at least one form chosen from a solution, a gel, and a foam. In certain embodiments, the second material comprises a catalyst such as an acid or base, or plasticizers. In one non-limiting embodiment, the prepolymer has a temperature above the blood vessel, such that introducing the prepolymer to a vascular site of the blood vessel polymerizes the prepolymer. In another embodiment, the composition comprises a prepolymer, and a radio opaque agent comprising at least one metal, whereby the agent absorbs electromagnetic radiation thereby heating the prepolymer to at least partially polymerize the prepolymer. In one non-limiting embodiment, the radio opaque agent comprises tantalum powder.

In accordance with the present invention, an apparatus for the embolization of a vascular site in a blood vessel comprises a catheter to deliver a prepolymer to the vascular site and a fiber optic, wherein the fiber optic is detachably connected to the catheter, whereby the prepolymer is adapted to at least partially polymerize in situ by introducing light waves from the fiber optic. In another embodiment, the apparatus comprises a catheter, a heating element, and a temperature sensing element, wherein the temperature sensing element provides temperature feedback to avoid at least partially polymerizing the prepolymer delivered by the catheter. In one nonlimiting embodiment, the heating element and the temperature sensing element can be positioned within the catheter, with the sensing element distal to the heating element.

In accordance with the present invention, an apparatus for the embolization of a vascular site in a blood vessel comprises a catheter comprising (i) an inner dissolved polymer stream, and (ii) an outer flush stream, wherein the flush steam is adapted to remove a solvent from the dissolved polymer to cause the dissolved polymer to precipitate. In certain embodiments, the flush stream is further adapted to maximize an interface between the dissolved polymer and the flush steam distal to the catheter.

In accordance with the present invention, a liquid embolic composition comprises a liquid embolic solution and fibers adapted to anchor the liquid embolic solution to a vascular site in a blood vessel.

In accordance with the present invention, an apparatus for embolizing a vascular site in a blood vessel comprises a catheter and a detachable catheter tip, wherein the catheter tip can be detached by an operator through a mechanically activated or heat activated detachment link.

In accordance with the present invention, a liquid embolic composition comprises a liquid embolic solution and a blood-soluble gas, wherein the composition forms a foam for delivery of the liquid embolic solution to a vascular site in a blood vessel. In certain embodiments, the gas can be carbon dioxide.

In accordance with the present invention, an apparatus for the embolization of a vascular site in a blood vessel comprises a catheter comprising a first channel for delivery of a dissolved polymer to the vascular site, and a second channel for delivery of a material adapted to accelerate precipitation of the dissolved polymer. In certain embodiments, the second channel delivers the material inside the dissolved polymer to begin precipitation from within the dissolved polymer. In other embodiments, the second channel delivers the material outside the dissolved polymer to diffuse a solvent out of the dissolved polymer.

In accordance with the present invention, a method for embolizing a vascular site in a blood vessel comprises delivering a first material to the vascular site to promote cell adhesion, delivering a second material to the vascular site to fill at least a portion of a volume of the vascular site, and delivering a third material to said vascular site to protect said vascular site, whereby the second material fills the volume between the first material and the second material.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 illustrates an embodiment for delivery of a first material and a second material.

FIG. 2A illustrates one non-limiting embodiment, for delivery of the prepolymer and light waves to the vascular site.

FIG. 2B illustrates one non-limiting embodiment, for delivery of the prepolymer and light waves to the vascular site.

FIG. 3A-3C illustrate one non-limiting embodiment for diffusion of a solvent from a dissolved polymer.

FIG. 4 illustrates one non-limiting embodiment for a catheter with a heater.

FIG. 5 illustrates one non-limiting embodiment for a composition with fibers.

FIG. 6 illustrates one non-limiting embodiment for a composition comprising a foam.

FIG. 7 illustrates one non-limiting embodiment for an externally activated composition.

FIG. 8A-8B illustrate one non-limiting embodiment for a catheter with a detachable tip.

FIG. 9 illustrates one non-limiting embodiment for a composition with laser light activated microbeads.

FIG. 10 illustrates one non-limiting embodiment for a serial delivery of liquid embolic solutions.

### DETAILED DESCRIPTION OF THE EMBODIMENTS

Reference will now be made in detail to the present embodiment(s) (exemplary embodiments) of the invention, an example(s) of which is (are) illustrated in the accompanying drawings. Wherever possible, the same reference numbers will be used throughout the drawings to refer to the same or like parts.

In one non-limiting embodiment, the compositions of the present invention function as protective material and may even include a drug. Also, the material can be adhesive-like and capable of changing from a first state of a material for ease of delivery (allowing injection through the catheter) to a second state having a solid, semi-solid or paste-like form, which conforms to the vascular site in the presence of blood flow to provide bulking or filling over flaps, aneurysms, perforations, cracks, and other malformations. The first state has low viscosity so that the composition flows through the catheter lumen and out of the small port in the proximal end portion of the catheter tip. The second state at least partially solidifies and sets-up at the vascular site and can remain in place when subjected to blood flow, torsion, and other physical events.

In one non-limiting embodiment, a composition of the present invention comprises a prepolymer, which can polymerize into a polymer. The polymer can be biocompatible or not biocompatible. The prepolymer is adapted to at least partially polymerize in situ when an activator is introduced to the vascular site where the prepolymer has been placed. The at least partially polymerized prepolymer thereby embolizes the blood vessel. In one non-limiting embodiment, the prepolymer comprises a light-activated crosslinking material.

The term “activator” refers to the switch that begins the conversion of the composition of the present invention from the first state to the second state. The activator can be a source of energy such as electromagnetic radiation, ultrasound, mechanical force, magnetic fields, heating or cooling etc. or a material such as a catalyst, acid, base, plasticizers, etc.

Various kinds of polymeric material can provide the desired first state and second state functionality of the present invention. In one nonlimiting embodiment, a prepolymer which polymerizes in situ with light or UV, for example poly-L-lactic acid and other materials known in the art of orthopedic or arthroscopic surgery can provide the functionality of the present invention. In one non-limiting embodiment, a prepolymer and plasticizer, for example polyvinyl alcohol and collagen can provide the functionality of the present invention. In one non-limiting embodiment, two-component systems, which can from a foam and cross-link in situ, for example a polymesh prepolymer can provide the functionality of the present invention.

In certain embodiments, light or heat activator can be used for the polymerization process. Acrylates, methacrylates, acrylamides, methaacrylamides, styrenes, vinyls, and allyls, can be combined with urethane, urethane carbonates, silicone or epoxy. Some examples include urethane acrylates and epoxy acrylates from Sartomer, Exton, Penn. (i.e. CN 950, 960, 970, 980, 014, 11, 114, 120), urethane acrylates from Polymer Systems Corp., Washington (i.e. Purelast®), acrylate and methacrylate epoxies and urethanes from Echo, Inc., epoxy and urethane acrylates available from Cargill, Inc., radiation curable acrylic resing from P. D. George Co., St. Louis, Mo. (i.e. Tritherm®, Terasod®, Pedigree® and Soderite®) urethane olefin precursors from Hampshire Chemical Company, Lexington, Mass. (i.e. Hypol® 2000), Monomer-Polymer and Dajac Laboratories, Inc., Feasterville, Penn. (i.e. Photomer® 6230), Henkel Corporation, Germany (i.e. Photomer® 6264), and silicone acrylate from NuSil.

In one non-limiting embodiment, the composition can be a light cross-linkable monomer system. Examples of such a system are photo-activated catalyst and an unsaturated polyester. The unsaturated polyester can be prepared by the methacrylation of polycaprolactone triol or diol. The photo-initiator can be comprised of n-phenyl glycine and di-camphorquinone. The unsaturated polyesters can be blended with other biodegradable polyesters to optimize the physical properties of the composition, both before and after polymerization.

In one non-limiting embodiment, photo-activated materials can be used in the production of photo-activated prepolymers with functionality according to the present invention. Photo-activated materials include, but are not limited to groups carbines and nitrenes formed photo-chemically from a precursor. Many methods of producing photo-activated prepolymers are known in the art of polymer chemistry. The prepolymer provides a low viscosity to flow through the lumen of the catheter; a photo-activated functionality to cross-link inter-molecularly and to the surrounding tissue; structural integrity to withstand the systolic pressure present in the blood vessel; biocompatibility; and tissue growth so that an epithelial layer can form over the at least partially polymerized prepolymer.

In certain embodiments, examples of photo-activated materials (initiators) include vazos, irgacures, peroxides, acetophenones, α-alkoxy deoxybenzoins, α, α-dialkoxy deobenzoins, α, α-dialkoxy acetophenones, 2-hydroxy-2,2-dialkyl acetophenones, benzophenones, thioxanthones, benzils, and other compounds suitable for photo and/or thermal initiation.

In one non-limiting embodiment, the composition comprises a synthetic or natural material specifically modified to provide the functionalities previously mentioned for a polymer that can be activated by light. Examples of such materials include, but are not limited to collagen, fibrin, and resorbable materials such as polylactic acid, polyglycolic acid, copolymers of polylactic acid and polyglycolic acid, polyphosphazenes, caprolactone, and polymers containing polyhydroxybutyric acid, and non-resorbable polyphosphazenes, polyesters, polyurethanes, and silicones.

In one non-limiting embodiment, photo-activated catalysts can be added to cross-link the prepolymer. An example of a photo-activated catalyst, which can be used to initiate cross-linking of the prepolymer inter-molecularly and to surrounding tissue is the aryl acid, sulfosuocinimidyl 6(4′ azido-2′-nitrophenylamino) hexanoate (Sulfo-SANPAH).

In one non-limiting embodiment, the photo-actiavated or catalyst activated prepolymer can be used as a drug delivery matrix with the incorporation of a desired drug.

In one non-limiting embodiment, a photo-activated prepolymer can be produced from a polyphosphazene trimer. Following extraction of impurities from the starting trimer via sublimation, polymerization of the polyphosphazene is affected by heating the material at 250° C. in a tube sealed under vacuum until such time that a substantial increase in viscosity is noted. The resulting polymer is further processed to remove the low molecular weight fractions via sublimation. The prepolymer thus created is dissolved in a suitable solvent such as anhydrous tetrahydrofuran for further reaction.

The polyphosphazene prepolymer is further prepared for attachment of the photo-activated catalyst by first stoichiometrically attaching an aliphatic molecule to the substrate in sufficient quantities to replace and convert the desired percentage of the available chlorine groups of the polyphosphazene to non-reactable terminals thus leaving only a limited number of sites available for further reaction. One molecule that has been found to be particularly useful for the displacement of the chlorine terminals is propylamine. The ultimate cross-link density can be controlled by limiting the number of available binding chlorine sites on the polyphosphazene. Once the appropriate quantity of chlorine groups have been bound, the polyphosphazene is then ready for the attachment of the photo-activated (BOC-propanolamine) catalyst.

Further in the preparation process, a hydroxylamine can be prepared in known manner for attachment to the previously prepared polyphosphazene by first creating the hyroxylamine with a BOC-ON (N-ter-butoxycarbonyl) thus protecting the amine terminal from further chemical modification. The BOC-ON protected molecule is subsequently attached to the polyphosphazene substrate via the hydroxy terminal.

Following attachment of the BOC-hydroxylamine to the polyphosphazene, the BOC group is removed thus availing the primary amine group for use in the attachment of a photo-activated compound such as SADP. Attachment of the photo-activated group is necessarily accomplished in the dark. The preparation process is known and is briefly described below:

In one non-limiting embodiment, the preparation of the photo-activated polyphosphazene prepolymer can accomplished as follows: prepare polyphosphazene prepolymer (polymerize polyphosphazene); prepare hydroxylamine by attaching BOC group to amine terminal, stoichiometrically bind limited number of chlorine groups of the substrate molecule, attachment of BOC protected Hydroxylamine to substrate, remove BOC functionality to expose amine group, attach SADP group to the exposed primary amine terminal of the hydroxylamine.

In certain embodiments, the activator can be a second material to react with the prepolymer first material. Examples of such materials include urethanes, epoxies, silicones, and acid or base cured monomers. Other materials include cyanoacrylates, adhesives, and moisture cure silicones from Dow Chemical Corp., NuSil, or Shin Etsu, urethane acrylate adhesives from Loctite (i.e. 3321, 3311, 3211), urethane based adhesives from Air Products and Chemicals (i.e. Airthane®, Polathane®, Ultracast®, and Cyanoprene®), from Conap, Inc. (i.e. Conathane®), from ICI Polyurethanes Group (i.e. Rubinate®), from Jedco Chemical Group (i.e. Jedbond®), and medical grade adhesives from Masterbond, Inc. and Permabond, Inc.

In one non-limiting embodiment, a synthetic or natural material can be specifically modified to provide chemical activation for cross-linking. Examples of such materials include, but are not limited to prepolymers with primary amine terminating side chains which can be cross-linked inter-molecularly and with tissue using N-hydroxysuccinimide ester catalysts such as BIS (sulfosuccinimidyl) material. These materials can also be used for structural support or improving surface properties. A foamable TDI-based polyurethane prepolymer can be used to foam and cross-link in situ upon mixing with water. The water solution can comprise structural elements like collagen or agents like heparin.

In one non-limiting embodiment, the composition of the present invention comprise a first material adapted to at least partially polymerize in situ and a second material adapted to initiate polymerization. The first material can be a prepolymer comprising a polyether polyol present at a concentration of between 2% and 10%, or between 4% and 8% by weight, based on the weight of the composition. The polyether polyol can comprise at least one material chosen from linear and branched polyols with polyether backbones of polyoxyethylene, polyoxypropylene, and polytetramethylene oxide (polyoxytetramethylene), and copolymers thereof. The polyether polyol can have molecular weights in the range of 250 to 2900.

The prepolymer further comprises an isocyanate present in excess in of the polyether polyol, e.g., at a concentration of between 30% and 50%, or between 35% and 45%, by weight. The isocyanate can be an aromatic (poly)isocyanate comprising at least one material chosen from 2,2′-, 2,4′-, and 4,4-diphenylmethanediisocyanate.

The prepolymer further comprises between 1% and 50% by weight of polymer comprising hydroxyl- or amine-terminated compounds of at least one material chosen from polybutadiene, polyisoprene, polyisobutylene, silicones, polyethylenepropylenediene, copolymers of butadiene with acryolnitrile, copolymers of butadiene with styrene, copolymers of isoprene with acrylonitrile, and copolymers of isoprene with styrene. In one non-limiting embodiment, the polymer comprises hydroxyl-terminated polybutadiene, present at a concentration of between 5% and 30%, by weight, or between 5% and 20% by weight.

The second material comprises a polyether polyol as described above for the prepolymer and is present at a final concentration of between 20% and 60%, or between 30% and 45%, by weight. The second material further comprises a catalyst comprising at least one material chosen from linear (e.g., cyclohexane dimethanol) and branched (e.g, trimethyloyl propane) chain extenders, present at a final concentration of between 1 % and 20%, or between 5% and 15%, or present at a final concentration of between 1% and 20%, or between 1% and 10%, by weight of the final composition.

In one non-limiting embodiment, the first material comprises a prepolymer comprising at least one alkyl cyanoacrylate chosen from methyl, n-butyl, isobutyl, n-hexyl and 2-hexyl cyanoacrylate. The second material comprises an oligomer (from 2 to 20 repeating monomer units) or polymer formed from a composition of alkyl cyanoacrylate monomer, and a plasticizer. The term “plasticizer” refers to liquid materials which can be added to solid polymers to render them flexible. Plasticizers can be chosen to be compatible on a molecular scale with the specific polymer being plasticized and biocompatible. The plasticizer can be soluble or dispersible in alkyl cyanoacrylate, which increases the flexibility of the resulting polymer, and which is compatible with the vascular site in the blood vessel. Examples of plasticizers include, but are not limited to, alkyl esters of fatty acids such as alkyl myristates, alkyl laureates, alkyl stearates, and alkyl succinates, acetyl tri-n-butyl citrate, butyl benzyl phthalate, dibutyl phthalate, diethyl phthalate, dimethyl phthalate, dioetylphthalate, n-butyryl tri-n-hexyl citrate, benzoate esters of di- and poly-hydroxy branched aliphatic compounds, tri(p-cresyl) phosphate, and other plasticizers known in the art of polymer chemistry.

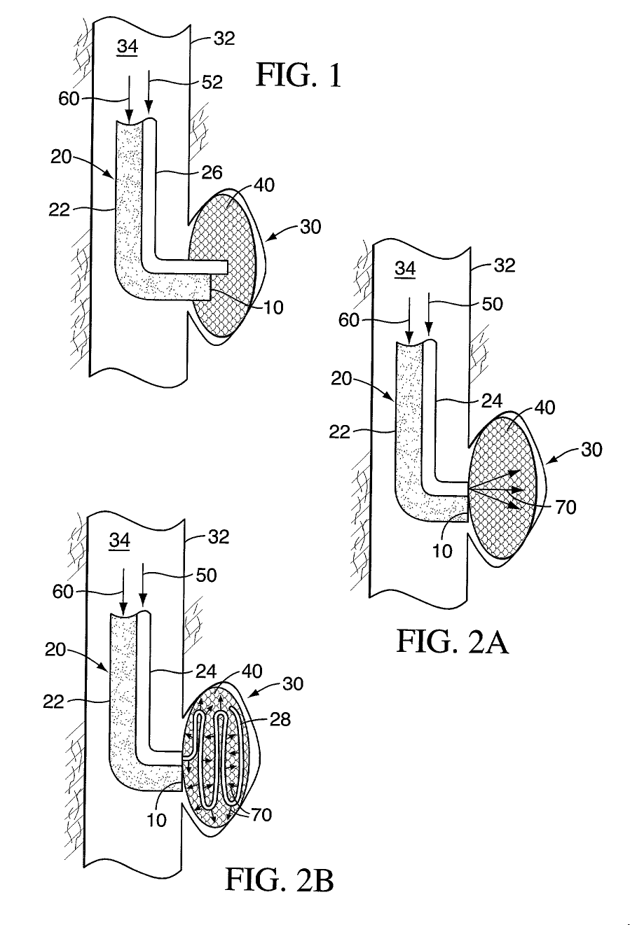

FIG. 1 illustrates one embodiment with a catheter delivering a first material and a second material. Catheter [20] has two channels, the first channel [22] carries the first material [60] and the second channel to carry the second material [26] to the vascular site [30] in the blood vessel [32]. The prepolymer [40] coming out of the catheter tip [10] fills the vascular site [30]. The second material [26] is positioned near the catheter tip [10]. During delivery of the prepolymer [40], the blood flow [34] is not obstructed by the catheter [20]. The second material [52] flows through second channel [26] to activate the prepolymer [40] to activate the prepolymer [40] coming out of catheter tip [10]. Once the prepolymer [40] at least partially polymerizes, the catheter [20] can then be removed from the blood vessel [32]. The vascular site [30] is then embolized.

In one non-limiting embodiment, the prepolymer can comprise a heat-activated cross-linking material. The heat-activated cross-linking can be a polyurethane foam formed from the mixture of isocyanates and polyols, a latex material or a polymer formed from a free radical reaction with a secondary catalyst added after the polymer. The heat-activated cross-linking material has a curing temperature, the temperature at which the material at least partially gels, above the temperature of the environment of the vascular site in the blood vessel. Alternatively, the heat-activated cross-linking material has a melting temperature above the temperature of the environment of the vascular site in the blood vessel. The polymeric material can be altered by heating or cooling by a heating element or a heating fluid.

In one non-limiting embodiment, a radio-opaque agent can be added to the composition of the present invention. The agent can either be biodegradable or not biodegradable and allows for monitoring the delivery of the composition to the vascular site. The agent comprises of a compound or composition which selectively absorbs or deflects radiation making the agent visible under x-ray, or any like imaging technique. Typically such agents include, iodinated oils, and brominated oils, as well as commercially available compositions, such as Pantopaque™, Lipiodol and Ethiodol. These commercially available compositions act as radio opaque agents, and also dilute the amount of liquid monomer thereby slowing the rate of polymerization. The agent can also comprise metals, such as, gold, platinum, palladium tantalum, titanium, tungsten as well as alloys and mixtures thereof, or salts such as barium sulfate and the like. In the embodiments using metal in the agent, the agent can be adapted to absorb the electromagnetic energy and heat the prepolymer composition, thus behaving as the activator. In one non-limiting embodiment, the agent comprises tantalum powder.

In one non-limiting embodiment, an apparatus with a heating element can act as activator for the prepolymer. An example of a heating element can be a coiled structure where an elongate heating element, e.g., a wire, is wrapped in a helix about a supporting structure at the distal end of the catheter. Successive turns of the helical coil are spaced-apart to permit flow of the prepolymer or heating fluid and to minimize the thermal effect of adjacent turns on each other. By suspending the heating element away from the catheter, the exposed surface area of the heating element is maximized, with only the suspension points being blocked.

The means for suspending the heating element from the surface of the catheter can take a variety of forms. For example, a plurality of discrete support posts on the surface of the catheter tip. Alternatively, the coil heating element can be shaped so that it defines integral support posts in its own structure or comprises a plurality of axial ribs formed in the catheter tip itself. This configuration can form troughs between adjacent ribs defining the circulation region between the heater and the catheter.

In one non-limiting embodiment, the heating element can be within the catheter heating the prepolymer prior to exiting from the catheter tip. FIG. 4 illustrates an embodiment of heating within the catheter and regulation by a temperature sensing element. Catheter [20] delivers heat-activated prepolymer [94] to the vascular site [30]. Heating element [90] is positioned within the catheter [20] such that prepolymer [94] flows over heating element [90]. Heating element [90] can be an electric resistance heater or a laser adsorption heater. Catheter [20] also has a temperature sensing element [92] positioned distally (proximal being oriented toward the user and distal toward the site) to the heating element [90] to control the temperature of prepolymer [94] that exits catheter tip [10]. This provided temperature feedback and allows automatic or operator controlled modification of the heat provided by the heating element [90] to maintain the prepolymer [94] fluid until the catheter tip [10]. This can avoid having the prepolymer at least partially polymerize in the catheter and prevents overheating the site being filled.

In one non-limiting embodiment, the prepolymer delivered to the vascular site can be at a temperature below the body temperature and temperature at the vascular site. The temperature of gelling of the prepolymer can be adapted to avoid any premature gelling as the prepolymer travels through the catheter, such that an active heating by a heating element or heating fluid has to raise the temperature of the vascular site above normal (avoiding damage to the vascular site) to gel the prepolymer.

In one non-limiting embodiment, the first material and the second material can be mixed and heat added via a heating element or heating fluid to activate the polymerization of the prepolymer.

In one non-limiting embodiment, an apparatus with a fiber optic can act as activator for the prepolymer. The fiber optic can deliver light waves, ultraviolet waves (using an excimer laser source as known in the art of laser angioplasty), or infrared waves (used in infrared endoscopy as known in the art of medical imaging). In one non-limiting embodiment, the fiber optic can be fixed to the catheter to introduce light waves to the vascular site. Catheters for delivering light to a distal portion of the body for performing photo-therapeutic procedures are known in the art of catheters, endoscopes, and bougies for laparoscopic surgery. The amount of light delivered to the distal portion of the body at the vascular site can be increased through the use of a diffuser. FIG. 2A illustrates one embodiment with a catheter with fiber optic. Catheter [20] has two channels: the first channel [22] carries the composition [60] and the other to carry the fiber optic [24] to the vascular site [30] in the blood vessel [32] coming out of the catheter tip [10] fills the vascular site [30]. A fiber optic [40] is positioned near the catheter tip [10]. During delivery of the prepolymer [40], the blood flow [34] is not obstructed by the catheter [20]. The light source [50] illuminates the fiber optic [24] to activate the prepolymer [40] with light waves [70] emitted as the prepolymer passes by the fiber optic [28]. Once the prepolymer [40] at least partially polymerizes, the catheter [20] can then be removed from the blood vessel [32].

In one non-limiting embodiment, the amount of light delivered to the vascular site can be increased by use of a transillumination fiber optic with the light delivery ends of the optical fibers to redirect axially directed light propagating through the fiber optic radially outward. This can be achieved by compressing a portion of the fiber near the distal end of the catheter by means of a die having a central bore dimensioned to accommodate a fiber optic with one or more split rings projecting into the fiber and coaxial with the bore. This can be done by compressing a circumferential annular groove into the wall of a fiber optic with a pair of steel plates having a hole or bore. The result is that axially propagating light is refracted at the air/fiber interface to exit the fiber in a radial direction.

In one non-limiting embodiment, the fiber optic can be detachably connected to the catheter such that it can be inserted into the vascular site with the prepolymer and illuminate the prepolymer from within. The fiber optic also provides structure onto which the prepolymer can polymerize. The fiber optic is connected to the catheter during deployment and polymerization and then can be detached when the catheter is removed.

FIG. 2B illustrates one embodiment with a detachable portion of the catheter. Catheter [20] has two channels: the first channel [22] carries the composition [60] and the other to carry the fiber optic [24] to the vascular site [30] in the blood vessel [32]. The prepolymer [40 ] coming out of the catheter tip [10] fills the vascular site [30]. A detachable portion of the fiber optic [28] is positioned before or during prepolymer delivery. The detachable portion of the fiber optic [28] can be transported to the vascular site [30] within a sheath (not shown) coaxially disposed, with a sufficient length to carry the detachable portion of the fiber optic [28]. Removal of the sheath allows the detachable portion of the fiber optic [28] to be positioned into the vascular site [30]. Alternatively, the detachable portion of the optic [28] can be transported to the vascular site [30] within first channel [22]. Delivery of the prepolymer [40] allows the detachable portion of the fiber optic [28] to be positioned into the vascular site [30]. In such a configuration, the detachable portion of the fiber optic [28] is coated with prepolymer [40] immediately upon positioning.

During delivery of the prepolymer [40], the blood flow [34] is not obstructed by the catheter [20]. The light source [50] illuminates the fiber optic [24] to activate the prepolymer [40] with light waves [70] emitted through the side of the detachable portion of the fiber optic [28]. Once the prepolymer [40] at least partially polymerizes, the detachable portion of the fiber optic [28 ] is detached and remains lodged within the prepolymer [40]. The catheter [20] can then be removed from the blood vessel [32]. The vascular site [30] is then embolized. The detachable portion of the fiber optic [28] can be broken or melted away from the fiber optic [24] either automatically or by the operator of the catheter remotely using a sheath (not shown) which extends the length of the catheter except over the detachable portion of the fiber optic [28]. The sheath provides a cutting means or heating means to break or melt the detachable portion of the fiber optic [28].

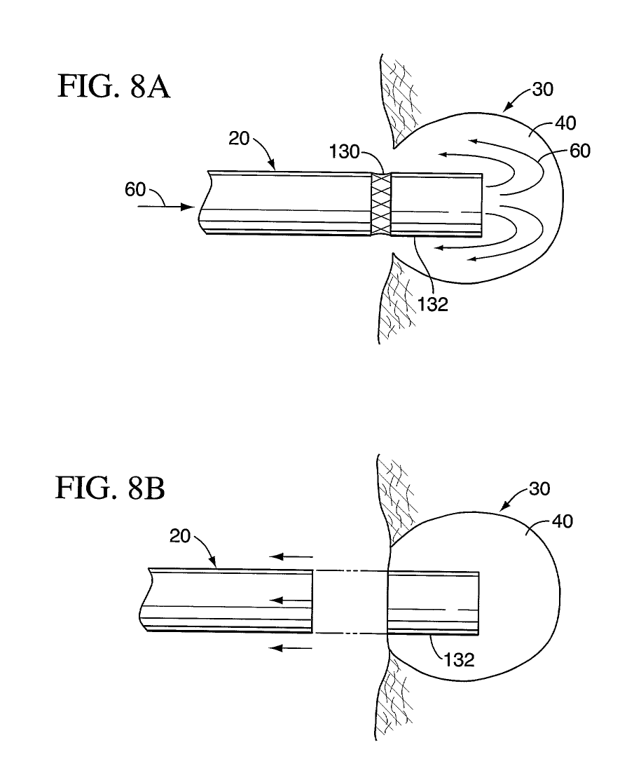

In one non-limiting embodiment, a detachable tip of the catheter can remain lodged within the at least partially hardened prepolymer. This allows removal of the main catheter from the blood vessel, while the detachable tip of the catheter remains to provide the activator while the prepolymer at least partially polymerizes around the detachable tip of the catheter. FIGS. 8A-8B illustrate one embodiment of a catheter with a detachable tip. Catheter [20] is positioned inside vascular site [30] such that the detachable tip [132] lies within the vascular site [30] to be filled with prepolymer [40]. When the prepolymer [40] has been delivered and at least partially hardened, the detachment link [130] is broken or melted leaving the detachable tip [132] lodged within the at least partially hardened prepolymer [40]. The main catheter [20] is removed from the vascular site [30]. The detachment link [130] can be broken or melted by the operator of the catheter remotely using a sheath (not shown) which extends the length of the catheter except over the detachable tip [132]. The sheath provides a cutting means or heating means to brake or melt the detachment link [130].

In one non-limiting embodiment, the catheter has three channels. The first and second channels provide the first and second materials that polymerize in situ when delivered to the vascular site. The third channel delivers a solubilizing agent which at least partially un-gels a small portion of the prepolymer that has hardened around the catheter tip. The solubilizing agent allows the prepolymer to become maneuverable enough to dislodge the catheter, but not viscous enough to travel downstream of the vascular site. The blood flow removes the solubilizing agent thereby allowing the prepolymer to re-gel after the catheter has been removed.

In one non-limiting embodiment, microbeads can be used as the activator. The term “microbeads” refers to any particle of smaller size adapted for delivery within a catheter. In the embodiment where the first material and second material are delivered independently through the first channel and second channel of the catheter, the first material and second material can be delivered in the from of microbeads coated with a biocompatible material such that the first material and second material are prevented from polymerizing. Focused ultrasound can be used to rupture the beads and release the first material and second material thereby allowing them to at least partially polymerize. In one non-limiting embodiment, the microbead coating can comprise the radio-opaque agent. An endpoint for introducing focused ultrasound can be determined to avoid distal embolization. The ultrasound vibrations are adapted to avoid harming the tissue surrounding the vascular site. The microbeads can be 1-50 microns. In one non-limiting embodiment, a Hewlett-Packard Sonos 1000 ultrasonic machine can be used with a 1-5 MHz transducer by Vingmed to create an acoustic pulse pressure greater than 0.05 MPa to rupture the microbeads and allow the first and second material to at least partially polymerize.

In one non-limiting embodiment, the microbead coating comprises magnetic particles that can be activated by a magnetic field outside the body. Microbeads comprising the first material and the second material can be delivered to the vascular site and then a magnetic field can activate the metal to rupture the microbeads thereby releasing the first and second material and at least partially polymerizing. The magnetic particles can be composed of a variety of metals including ferromagnetic particles, such as Fe₃O₄, iron carbonyls, combinations of various transition metal oxides (oxides of iron, nickel and zinc), metals (cobalt, copper, gold, and silver), and alloys (such as copper containing gold and silver alloys). The microbead coating can comprise ceramics comprising the magnetic particles, where the ceramics that are compatible with the first and second materials within the microbeads. Other coatings that are compatible with the first and second materials. Ceramics can be chosen to have little to no reaction with the first and second materials, and to protect the metal from oxidation. Alternate coatings can include, but not be limited to, methacrylates, alginates, dextran, polyacrylates, polyvinyl pyrrolidone (if the ferrous material is fully oxidized).

The magnetic particles can have a Curie temperature of from 40° C. to 95° C. Such high temperatures can be utilized in the microbeads because the small magnetic particles are a point heat source and do not cause significant tissue damage around the vascular site. A electromagnetic field with a frequency of 50-500 kHz, and a strength of about 1500-2000 Amps/m can rupture the microbeads.

In alternate embodiments, the microbeads with magnetic particles in their coating can be ruptured by 6-28 MHz radio frequency, or from 915 to 2450 MHz microwave radiation.

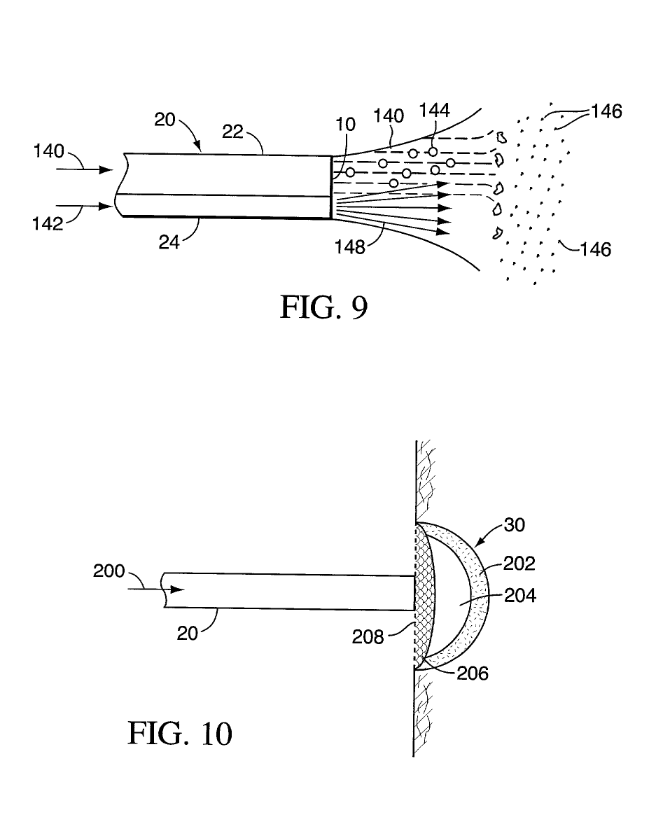

In another embodiment, a composition of the first material and second material contained in microbeads can be delivered to the vascular site by a catheter. The microbeads can then be melted releasing the second material and allowing the first material and the second material to at lest partially polymerize. FIG. 9 illustrates an embodiment where a catheter delivers a composition with microbeads to the vascular site and then melts the microbeads with a fiber optic emitting laser light. Catheter [20] delivers composition [140] through channel [22]. Catheter [20] also comprises fiber optic [24] connected to a laser light source [142]. The composition [140] upon exiting catheter tip [10] is bombarded with laser light [148] causing the microbeads [144] in composition [140] to melt. Once the microbeads [144] melt, they release a second material [146] which reacts with a first material in composition [140] to at least partially polymerize at the vascular site.

In one non-limiting embodiment, the apparatus an external means for delivery of the activator. Such external means include, but are not limited to, eddy currents, magnetic fields, or electromagnetic radiation (which can penetrate to the vascular site). In such embodiment, the prepolymer comprises magnetic particles. The magnetic particles can be activated by a electromagnetic field generated outside the body. FIG. 7 illustrates a heat-activated prepolymer with magnetic particles activated by an oscillating electromagnetic field. Catheter [20] delivers heat-activated prepolymer [124] to vascular site [30]. Prepolymer [124] comprises magnetic particles [120]. Electromagnetic coil [122] is placed outside the skin [126] in the proximity of the vascular site [30]. The electromagnetic coil [122] can be driven by an alternating current to generate a magnetic field or an oscillating electric field [128]. The field [128] interacts with the magnetic particles [120] heating the prepolymer [124] such that it at least partially polymerizes.

In one non-limiting embodiment, the present invention provides a method for embolizing a blood vessel by delivering a prepolymer composition to a vascular site in the blood vessel, introducing an activator the vascular site, where the activator at least partially polymerizes the prepolymer. The term “activator” refers to any of a wide variety of triggering mechanisms to polymerize the prepolymer. These mechanisms include, but are not limited to, electromagnetic radiation (which includes gamma rays, x-rays, ultraviolet waves, light waves, infrared waves, and radio waves), magnetic fields, ultrasound energy, and any material which can initiate the polymerization of the prepolymer (including an initiator, a catalyst, or any other polymeric material).

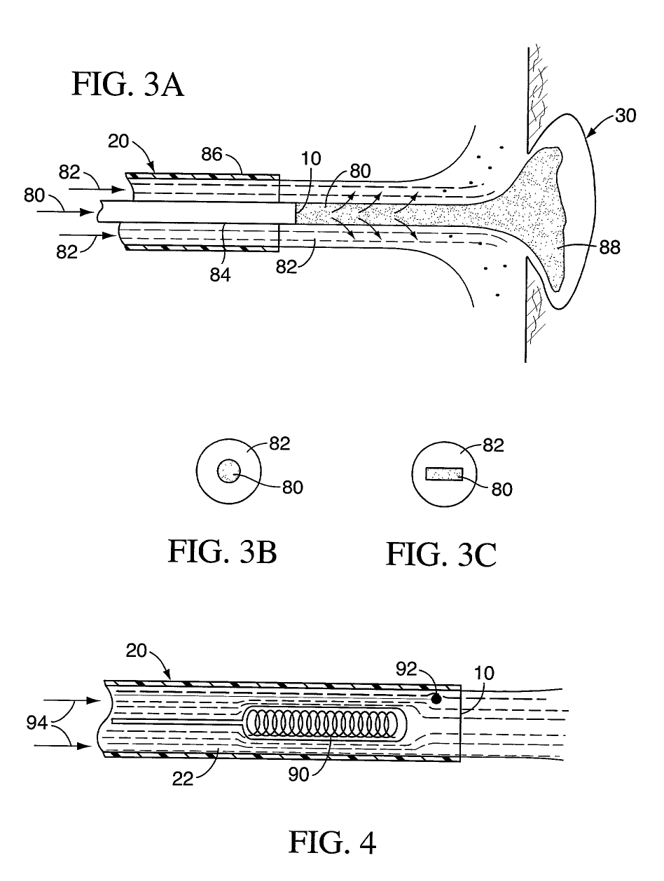

In one non-limiting embodiment, a composition of the present invention comprises a polymer dissolved in solvent. Several of these compositions are known in the art, as discussed above. However, the drawbacks in the slow precipitation of the polymer can be reduced by speeding up the reaction. In one embodiment, a flush stream injected coaxially with the stream of dissolved polymer. FIG. 3A illustrates several embodiments of a catheter with flush stream to accelerate the diffusion of the solvent out of the dissolved polymer solution, thereby accelerating the precipitation of the polymer at the vascular site of the blood vessel. Catheter [20] is placed near vascular site [+]. The dissolved polymer [80] and flush stream [82 ] are delivered through coaxial channels [84 ] and [86]. As dissolved polymer [80] exits catheter tip [10 ] diffuses out of the dissolved polymer [80] in the flush stream [82]. As the solvent [89 ] diffuses, polymer [88] precipitates in vascular site [30] forming a solid mass. FIG. 3B shows the cross-sectional view of the coaxial steams of dissolved polymer [80] and flush stream [82]. FIG. 3C shows an alternative cross-section for the streams of dissolved polymer [80] and flush stream [82]. This alternative configuration provides greater surface area for the diffusion of solvent into the flush stream.

In certain embodiments, solvents include, but are not limited to, dimethylsulfoxide, dimethylformamide, dimethylacetamide, ethanol, N-methyl pyrrolidone, ethyl lactate, acetone, or water and mixture of the above. The flush stream includes water or any other material to cause the diffusion of these solvents.

In an alternate embodiment, the dissolved polymer can be delivered to the vascular site as a foam. FIG. 6 illustrates the dissolved polymer solution mixed with high pressure carbon dioxide to create a foam. Dissolved polymer [114 ] is mixed with high pressure carbon dioxide gas [112 ] prior to traveling down catheter [20 ] to the vascular site [30]. The polymer [114 ] and carbon dioxide gas [122 ] mix to form a foam [110]. The foam [110 ] expands upon exit from catheter tip [10 ] to fill vascular site [30]. The carbon dioxide gas [116] diffuses out of the foam [110 ] precipitating the polymer into a solid mass. In alternate embodiments, the carbon dioxide gas can be replaced with other gases that have the ability to dissolve in blood.

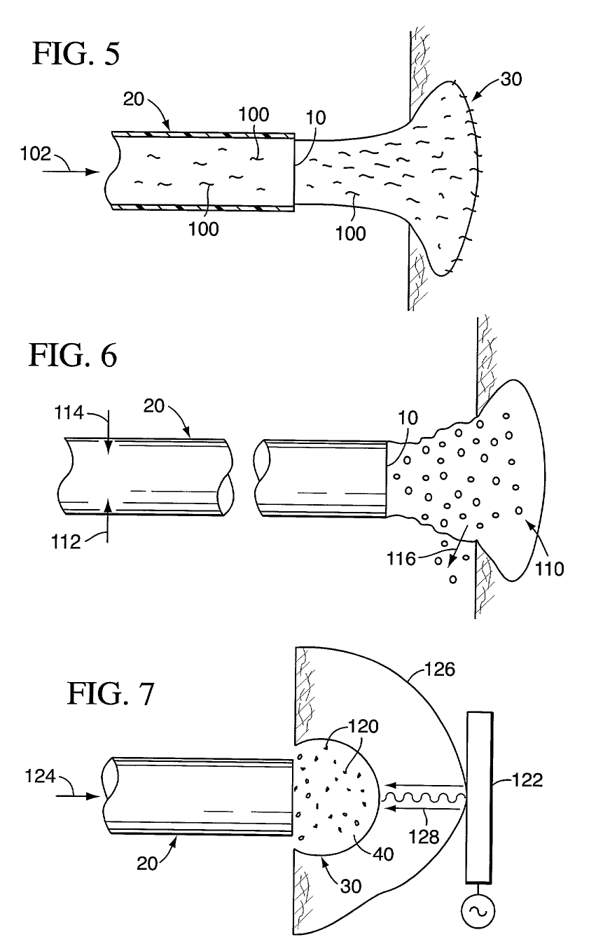

In one non-limiting embodiment, the composition of the present invention can comprise reinforcing fibers which provide structure unto which the prepolymer can at least partially polymerize and provide anchors for adhering to the surface cells of the vascular site. FIG. 5 illustrates a composition according to this invention comprising reinforcing fibers. Catheter [20] delivers composition [102] to vascular site [30]. The composition comprises reinforcing fibers [100]. The fibers [100] provide anchoring of the at least partially hardened composition in the vascular site.

In other embodiments, a liquid embolic solution can be adapted to cell adhesion, by addition of a cell-adhesion promoter. The promoters are known in the art of prosthetic surgery as composition that enable the human body to receive foreign materials and have that material coated to enable cell growth or cell adhesion to the prosthetic. The cell-adhesion promoters are desirable because they allow an aneurysm or other vascular site to cover itself and heal more quickly by promoting clotting and cell growth.

FIG. 10 illustrates one embodiment where a cell-adhesion promoter and a cell-proliferation promoter are used in a serial delivery of liquid embolic solutions. Stream [200] is sent through catheter [20] to vascular site [30]. Stream [200] can be modified so that it contains slugs or finite quantities of different materials sent in sequence for delivery to the catheter site in sequence. The first material to reach the vascular site [30] is a cell-adhesion promoter [202 ] to encourage growth and cell adhesion of the wall of vascular site [30]. The second material to reach the vascular site [30] is a filler [204] to fill the interior volume of the vascular site [30]. The third material to reach vascular site [30] is a protective material [206] to create the interface [208 ] between the blood and liquid embolic solutions filling vascular site [30].

The term “liquid embolic solution” refers to any composition of the present invention and any other solution delivered in a liquid state to embolizes a vascular site of a blood vessel.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method comprising:
delivering a prepolymer composition to a vascular site in a blood vessel;
introducing an activator to said vascular site;
wherein said introducing at least partially polymerizes said prepolymer composition in situ thereby embolizing said blood vessel.

2. A method according to claim 1, wherein:
said activator comprises at least one type of electromagnetic radiation chosen from gamma rays, X-rays, ultraviolet waves, light waves, infrared waves, and radio waves.

3. A method according to claim 1, wherein:
said activator comprises a magnetic field.

4. A method according to claim 1, wherein:
said activator comprises a composition.

5. A method according to claim 1, wherein:
said activator comprises ultrasound energy.

6. An apparatus comprising:
a catheter to deliver a prepolymer to a vascular site in a blood vessel
wherein said prepolymer is adapted to at least partially polymerize in situ by introducing an activator thereby embolizing said blood vessel,
wherein said catheter is adapted to at least partially adhere to said polymerized prepolymer.

7. An apparatus according to claim 6, wherein:
said catheter is adapted to introduce said activator.

8. An apparatus according to claim 7, further comprising
a fiber optic to introduce light waves to said vascular site.

9. An apparatus according to claim 7, further comprising
a heating element to introduce infrared waves to said vascular site.

10. An apparatus according to claim 7, further comprising
a heating fluid to introduce a temperature change to said vascular site.

11. An apparatus according to claim 6, wherein:
said activator is not introduced by said catheter.

12. An apparatus according to claim 11, further comprising
an instrument to deliver focused ultrasound to said vascular site.

13. An apparatus according to claim 11, further comprising
an instrument to deliver eddy currents to said vascular site.

14. An apparatus according to claim 11, further comprising
an instrument to deliver a magnetic field to said vascular site.

15. An apparatus according to claim 11, further comprising
an instrument to deliver electromagnetic radiation to said vascular site.

16. A composition comprising:
a prepolymer, wherein said prepolymer is adapted to at least partially polymerize in situ by introducing an activator thereby embolizing a vascular site in a blood vessel.

17. A composition according to claim 16, wherein:
said prepolymer comprises a light-activated cross-linking material.

18. A composition according to claim 16, wherein:
said prepolymer comprises a heat-activated cross-linking material.

19. A composition according to claim 16, wherein:
said prepolymer is contained within microbeads.

20. A composition according to claim 19, wherein:
said microbeads comprise magnetic particles.

21. A composition according to claim 20, wherein:
said magnetic particles adapted to heating by at least one external field chosen from a electromagnetic field, radio waves, and an microwaves.

22. A composition according to claim 19, wherein:
said microbeads comprise a catalyst to polymerize said prepolymer.

23. A composition comprising:
a first material, said first material adapted to at least partially polymerize in situ thereby embolizing a blood vessel,
a second material, said second material adapted to initiate said polymerization,
wherein said first material is at least one form chosen from a solution, a gel, and a foam.

24. A composition according to claim 23, wherein:
said second material comprises a catalyst.

25. A composition according to claim 24, wherein:
said catalyst comprises an acid or base.

26. A composition according to claim 24, wherein:
said catalyst comprises plasticizers.

27. A composition comprising:
a prepolymer adapted to at least partially polymerize in situ thereby embolizing a blood vessel,
wherein said prepolymer has a temperature above said blood vessel, such that introducing said prepolymer to a vascular site of said blood vessel polymerizes said prepolymer.

28. A composition comprising:
a prepolymer, and
a radio opaque agent comprising at least one metal,
whereby said agent absorbs electromagnetic radiation thereby heating said prepolymer to at least partially polymerize said prepolymer thereby embolizing a blood vessel.

29. A composition according to claim 28, wherein:
said agent comprises tantalum powder.

30. An apparatus comprising:
a catheter to deliver a prepolymer to a vascular site in a blood vessel; and
a fiber opticwherein said fiber optic is detachably connected to said catheter,
whereby said prepolymer is adapted to at least partially polymerize in situ by introducing light waves from said fiber optic.

31. An apparatus comprising:
a catheter;
a heating element; and
a temperature sensing element, wherein said temperature sensing element provides temperature feedback to avoid at least partially polymerizing a prepolymer delivered by said catheter.

32. An apparatus according to claim 31, wherein:
said heating element is positioned within said catheter.

33. An apparatus according to claim 32, wherein
said temperature sensing element is positioned within said catheter, distally to said heating element.

34. An apparatus comprising:
a catheter comprising (i) an inner dissolved polymer stream, and (ii) an outer flush stream, wherein said flush steam is adapted to remove a solvent from said dissolved polymer to cause said dissolved polymer to precipitate.

35. An apparatus according to claim 34, wherein said flush stream is further adapted to maximize an interface between said dissolved polymer and said flush steam distal to said catheter.

36. A composition comprising:
a liquid embolic solution; and
fibers, said fibers are adapted to anchor said liquid embolic solution to a vascular site in a blood vessel.

37. An apparatus comprising:
a catheter; and
a detachable catheter tip, wherein said catheter tip can be detached by an operator through a mechanically activated or heat activated detachment link.

38. A composition comprising:
a liquid embolic solution; and
a blood-soluble gas, wherein said composition forms a foam for delivery of said liquid embolic solution to a vascular site in a blood vessel.

39. A composition according to claim 38, wherein said gas is carbon dioxide.

40. An apparatus comprising:
a catheter comprising a first channel for delivery of a dissolved polymer to a vascular site in a blood vessel, and a second channel for delivery of a material adapted to accelerate precipitation of said dissolved polymer.

41. A composition according to claim 40, wherein said second channel delivers said material inside the dissolved polymer to begin precipitation from within the dissolved polymer.

42. A composition according to claim 40, wherein said second channel delivers said material outside the dissolved polymer to diffuse a solvent out of the dissolved polymer.

43. A method comprising:
delivering a first material to a vascular site in a blood vessel to promote cell adhesion;
delivering a second material to said vascular site to fill at least a portion of a volume of said vascular site;
delivering a third material to said vascular site to protect said vascular site,
whereby said second material fills said volume between said first material and said second material.
